(19) United States
(12) Patent Application Publication
(10) Pub. No.: US 2025/0264533 A1
(43) Pub. Date: Aug. 21, 2025

(54) METHOD AND SYSTEM FOR VERIFYING BATTERY INTEGRITY

(71) Applicant: SAMSUNG SDI CO., LTD., Yongin-Si Gyeonggi-do (KR)

(72) Inventor: Minsu KIM, Yongin-Si (KR)

(21) Appl. No.: 19/057,449

(22) Filed: Feb. 19, 2025

(30) Foreign Application Priority Data
Feb. 20, 2024 (KR) 10-2024-0024328

(51) Int. Cl. G01R 31/36; G01R 31/367; H01M 10/42

(52) U.S. Cl. CPC G01R 31/3648; G01R 31/367; H01M 10/4285

(57) ABSTRACT

A method of verifying battery integrity includes: collecting first data associated with electrochemical characteristics of a cell included in a battery; generating a first hash value associated with the cell based on the first data; and monitoring the battery based on the first hash value.

### CROSS-REFERENCE TO RELATED APPLICATION

The present application claims priority to and the benefit of Korean Patent Application No. 10-2024-0024328, filed on Feb. 20, 2024, in the Korean Intellectual Property Office, the entire disclosure of which is incorporated by reference herein.

### BACKGROUND

### 1. Field

Aspects of embodiments of the present disclosure relate to a method and system for verifying battery integrity.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Batteries, including secondary batteries, are widely used for having high energy density, long life, and light weight. However, if the batteries are repaired and replaced by a private repair shop rather than the battery manufacturer, there may be a risk that the battery cells, battery modules, and/or the like inside the battery may be replaced with aftermarket parts that are not genuine or OEM (e.g., original equipment manufacturer). If replaced with aftermarket parts, the stability of the battery may be compromised, and the user's trust in the battery manufacturer may be reduced.

The above information disclosed in this Background section is for enhancement of understanding of the background of the present disclosure, and therefore, it may contain information that does not constitute related (or prior) art.

### SUMMARY

Embodiments of the present disclosure may be directed to a method and system for verifying battery integrity.

These and other aspects and features of the present disclosure will be described in or will be apparent from the following description of embodiments of the present disclosure.

According to one or more embodiments of the present disclosure, a method of verifying battery integrity includes: collecting first data associated with electrochemical characteristics of a cell included in a battery; generating a first hash value associated with the cell based on the first data; and monitoring the battery based on the first hash value.

In an embodiment, the first data may include an impedance and a phase angle generated in response to applying a frequency and a voltage to the cell.

In an embodiment, the generating of the first hash value may include: preprocessing the first data; extracting features from the preprocessed first data; and generating the first hash value based on the extracted features.

In an embodiment, the preprocessing may include: performing a noise filtering on the first data; and normalizing the noise-filtered first data.

In an embodiment, the extracting of the features may include: generating frequency domain data based on the preprocessed first data; calculating statistical measurement values from the frequency domain data; and extracting the features from the statistical measurement values.

In an embodiment, the generating of the first hash value may include: generating, by a machine learning model, a feature vector based on the features; and generating the first hash value based on the feature vector.

In an embodiment, the machine learning model may be trained to cluster input data based on unsupervised learning, and may generate and output unique vectors based on principal component analysis.

In an embodiment, the first hash value and an identifier of the cell may be stored in a battery management system (BMS) of the battery.

In an embodiment, the monitoring of the battery may include: collecting second data associated with the electrochemical characteristics of the cell; generating a second hash value associated with the cell based on the second data; and comparing the first hash value and the second hash value with each other.

In an embodiment, the method may further include: generating a hash value of each of a plurality of cells included in a module of the battery; and generating a hash value of the module based on the hash value of each of the plurality of cells.

In an embodiment, the method may further include: generating a hash value of each of a plurality of modules included in the battery; and generating a hash value of the battery based on the hash value of each of the plurality of modules.

In an embodiment, the method may further include: generating hash values associated with replaced modules in response to replacing at least some of the plurality of modules; and updating the hash value of the battery based on the hash value of each of rest of the plurality of modules and the replaced modules.

In an embodiment, the method may further include determining an integrity status of the battery based on monitoring results of the battery.

In an embodiment, the method may further include providing a notification associated with the integrity status based on the integrity status.

In an embodiment, the monitoring may include: periodically measuring data associated with the electrochemical characteristics of the cell; and updating the first hash value associated with the cell based on the periodically measured data.

In an embodiment, the updating of the first hash value may include: generating an electrochemical pattern of the cell based on the periodically measured data; estimating future electrochemical characteristics of the cell based on the electrochemical pattern of the cell; and updating the first hash value based on the estimated future electrochemical characteristics.

In an embodiment, a battery management system of the battery may include a circuit for measuring the electrochemical characteristics of the cell.

In an embodiment, the first hash value and an identifier of the cell may be stored in a management server associated with the battery, and the management server may transmit a notification associated with monitoring results of the battery to a terminal of a user of the battery.

In an embodiment, a computer-readable non-transitory recording medium may have recorded thereon instructions for executing, on a computer, the method.

According to one or more embodiments of the present disclosure, a system for verifying battery integrity includes: a data collection part configured to collect data associated with electrochemical characteristics of a cell included in a battery; a hash generation part configured to generate a hash value associated with the cell based on the data; and a monitoring part configured to monitor the battery based on the hash value.

According to some embodiments of the present disclosure, unique values may be generated based on the unique characteristics of the cells included in a battery. Based on the unique values, a current state, a change in state, or an integrity of the battery may be checked (e.g., may be verified). Further, by monitoring the battery integrity, potential problems may be detected more quickly.

According to some embodiments of the present disclosure, a battery integrity verification system may be provided that may be easily compatible with and integrated into battery systems (e.g., existing battery systems). Further, by having hash values generated and stored in the internal memory of the battery management system, it may be possible to preclude security issues and connectivity issues that may arise from using data from an external database or a blockchain network in order to verify the battery integrity. Accordingly, the stability and reliability of the integrity verification system may be enhanced or improved.

According to some embodiments of the present disclosure, hash values of not only the battery cells, but also for modules and battery units, may be generated. Accordingly, the integrity of each of the battery cell, the module, and the battery may be verified. Further, by having the hash values generated and stored in the internal memory of the battery management system, it may be possible to preclude security issues and connectivity issues that may arise from using data from an external database or a blockchain network in order to verify the battery integrity.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 shows an example of a configuration of a battery integrity verification system according to an embodiment of the present disclosure.

FIG. 2 shows an example of a method of generating a hash value associated with a cell according to an embodiment of the present disclosure.

FIG. 3 shows an example of a method of generating a hash value from features according to an embodiment of the present disclosure.

FIG. 4 shows an example of a method of monitoring a battery cell according to an embodiment of the present disclosure.

FIG. 5 shows an example of a method of generating hash values of modules and a battery according to an embodiment of the present disclosure.

FIG. 6 shows an example of updating a hash value of a module that is a replacement according to an embodiment of the present disclosure.

FIG. 7 shows an example of a method of continuously updating hash values according to an embodiment of the present disclosure.

FIG. 8 is a schematic diagram showing a configuration in which a battery management system is communicably connected to a management server and a user terminal in order to provide a notification associated with battery integrity according to an embodiment of the present disclosure.

FIG. 9 is a flowchart showing an example of a method of verifying battery integrity according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of local patent laws.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

Throughout the specification, a “module” may refer to a battery module having a plurality of cells, and the terms “module” and “battery module” may be used interchangeably.

Throughout the specification, a “battery unit” may refer to a unit comprising a plurality of battery modules.”

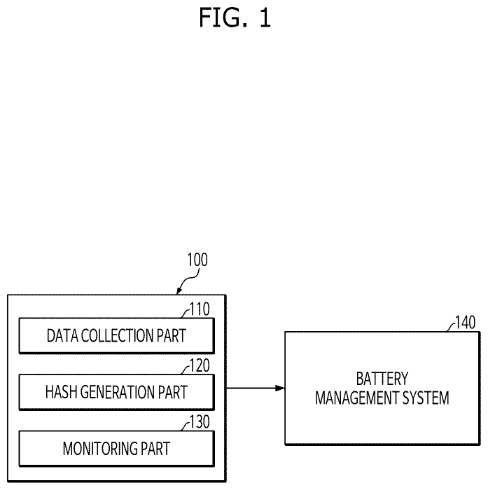

FIG. 1 shows an example of a configuration of a battery integrity verification system 100 according to an embodiment of the present disclosure.

In an embodiment, the battery integrity verification system 100 may include a data collection part 110, a hash generation part 120, and a monitoring part 130. The data collection part 110 may collect first data associated with electrochemical characteristics of a cell included in a battery (e.g., a particular or predetermined battery). The first data may include an impedance and a phase angle generated in response to applying a frequency (e.g., a particular or predetermined frequency) and a voltage (e.g., a particular or predetermined voltage) to the cell. Further, the data associated with the electrochemical characteristics may be measured using electrochemical impedance spectroscopy (EIS), but the present disclosure is not limited thereto.

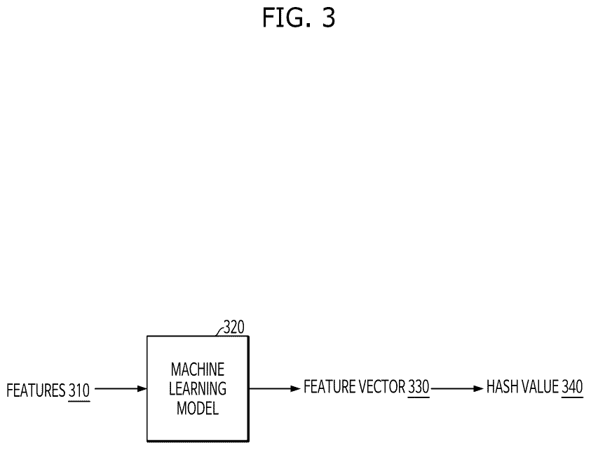

The hash generation part 120 may generate a hash value associated with the cell based on the first data associated with the electrochemical characteristics. In more detail, the hash generation part 120 may preprocess the first data. Further, the hash generation part 120 may extract features from the preprocessed first data. The hash generation part 120 may generate a first hash value based on the extracted features. An example in which the first hash value is generated based on the extracted features will be described in more detail below with reference to FIG. 3. The hash generation part 120 may store the generated first hash value and an identifier of the corresponding cell in a battery management system 140.

The electrochemical characteristics measured in a cell (e.g., a particular or predetermined cell) may differ from the electrochemical characteristics of other cells due to minute differences in the composition of materials, differences in thickness and density of electrodes included in the cells, an imbalanced distribution of an electrolyte, changes in a resistance inside the cells, temperature and pressure conditions during the manufacturing process, and/or the like in the process of manufacturing the cells included in a battery (e.g., a particular or predetermined battery). Accordingly, the hash value generated based on the first data associated with the electrochemical characteristics may be a unique value.

In an embodiment, the monitoring part 130 may monitor the state of the particular battery based on the generated first hash value. In more detail, when a part, such as a module or a cell, of the particular battery is replaced/repaired, the monitoring part 130 may control the data collection part 110 to collect second data associated with the electrochemical characteristics of the cell included in the particular battery. Further, the monitoring part 130 may control the hash generation part 120 to generate a second hash value associated with the cell based on the second data. The monitoring part 130 may monitor a state of the particular battery by comparing the first hash value stored in the battery management system 140 and the generated second hash value with each other.

In an embodiment, the monitoring part 130 may determine an integrity status of the battery based on the monitoring results of the corresponding battery state. Further, the monitoring part 130 may provide a notification associated with the integrity status to a computing device or a terminal associated with a manager, a user, or the like of the battery based on the integrity status.

In an embodiment, the monitoring part 130 may continuously monitor the changes in the battery state as the battery ages. In this case, the electrochemical characteristics of the cell may be measured by the battery management system 140. Further, the monitoring part 130 may update the hash value associated with the cell through continuous monitoring, and may store it in the battery management system 140. As another example, the monitoring part 130 may store the hash value associated with the cell in a management server.

The battery integrity verification system 100 is shown as being separated (e.g., distinct) from the battery management system 140 in FIG. 1, but the present disclosure is not limited thereto. For example, the battery integrity verification system 100 may be included in the battery management system 140.

As described above, the unique values may be generated based on the unique characteristics of the cells included in the battery. Based on the unique values, the current state, the change in state, or the integrity of the battery may be checked (e.g., may be verified). Further, by monitoring the battery integrity, potential problems may be detected more quickly.

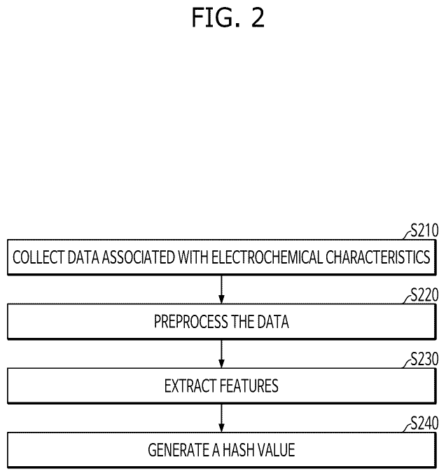

FIG. 2 shows an example of a method of generating a hash value associated with a cell according to an embodiment of the present disclosure.

In an embodiment, the hash value generation method may be performed by at least one processor (e.g., a processor of an integrity verification system). The hash value generation method may start, and the processor may collect data associated with the electrochemical characteristics of a cell included in a battery (e.g., a particular or predetermined battery) (S210). The data associated with the electrochemical characteristics may include an impedance, a phase angle, a current, a voltage, and the like generated in response to applying a frequency (e.g., a particular or predetermined frequency) and a voltage (e.g., a particular or predetermined voltage) to the cell.

The processor may preprocess the collected data (S220). In more detail, the processor may perform a noise filtering on the collected data. For example, the processor may remove a noise of a frequency higher than a cut-off frequency (e.g., a preset or predetermined cut-off frequency) from the collected data by applying a low-pass filter. Further, the processor may normalize the noise-filtered data. Accordingly, a scale of the noise-filtered data may be standardized and adjusted.

The processor may extract features from the preprocessed first data (S230). In more detail, the processor may generate frequency domain data based on the preprocessed data. A Fourier transform may be used to generate the frequency domain data, but the present disclosure is not limited thereto. Further, the processor may calculate statistical measurement values from the frequency domain data. The statistical measurement values may include a standard deviation, a mean, a median, a variance, a skewness, a kurtosis, and the like of the data. The processor may extract features from the statistical measurement values.

The processor may generate a hash value based on the extracted features (S240). In this case, the processor may generate a hash value based on the extracted features by using a machine learning model. An example of generating a hash value will be described in more detail below with reference to FIG. 3.

FIG. 3 shows an example of a method of generating a hash value 340 from features 310 according to an embodiment of the present disclosure.

In an embodiment, a processor (e.g., the processor of the integrity verification system) may generate the hash value 340 from the features 310 extracted from data associated with the electrochemical characteristics of a cell. In more detail, the processor may generate a feature vector 330 based on the features 310 by inputting the features 310 into a machine learning model 320. The machine learning model 320 may cluster the input data based on unsupervised learning, and may extract the center of the cluster. Further, the machine learning model 320 may reduce a dimension by applying principal component analysis (PCA) to the center of the cluster extracted. Accordingly, the machine learning model 320 may generate and output a unique vector (e.g., the feature vector 330). The feature vector 330 may be in the form of an encoded string, but the present disclosure is not limited thereto.

In an embodiment, the processor may generate the hash value 340 based on the feature vector 330. In more detail, the processor may generate the unique hash value 340 by applying a hash function to the feature vector 330. The hash function may include, but is not limited to, SHA-256. As such, a unique hash value may be generated effectively from the data associated with the electrochemical characteristics of the cell.

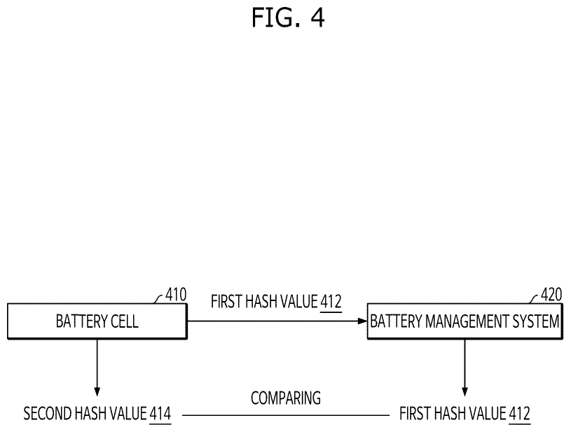

FIG. 4 shows an example of a method of monitoring a battery cell 410 according to an embodiment of the present disclosure.

In an embodiment, a processor (e.g., the processor of the integrity verification system) may generate a first hash value 412 from first data associated with the electrochemical characteristics of the battery cell 410. In this case, the processor may store the first hash value 412 and an identifier of the battery cell 410 in the internal memory of a battery management system 420.

In an embodiment, the processor may determine the integrity status of the battery cell 410 based on the hash value. In more detail, the processor may generate a second hash value 414 from second data associated with the electrochemical characteristics of the battery cell 410. Further, the processor may compare the first hash value 412 stored in the battery management system 420 and the generated second hash value 414 with each other. If (e.g., when) the first hash value 412 and the second hash value 414 are different from each other, the integrity of the battery cell 410 may be negated.

The battery integrity verification system including the processor described above may be easily compatible with and integrated into various suitable battery systems (e.g., existing battery systems). Further, by having the hash values generated according to the methods described above, and stored in the internal memory of the battery management system, it may be possible to preclude security issues and connectivity issues that may arise from using data from an external database or a blockchain network in order to verify the battery integrity. Accordingly, the stability and the reliability of the integrity verification system may be enhanced or improved.

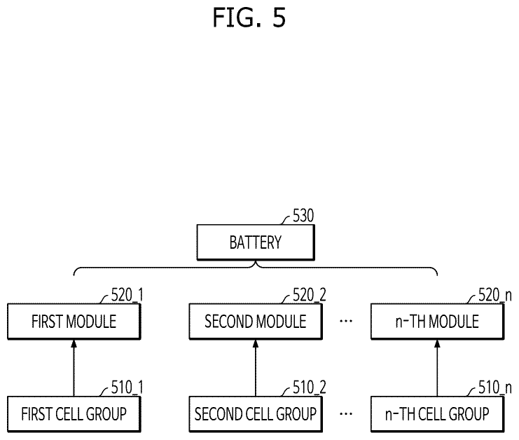

FIG. 5 shows an example of a method of generating hash values of modules 520_1 to 520_n and a battery 530 according to an embodiment of the present disclosure.

In an embodiment, a processor (e.g., the processor of the integrity verification system) may generate unique hash values of not only a battery cell, but also a module consisting of a plurality of cells. In more detail, the processor may generate a hash value of each of a plurality of cells in a cell group included in a module (e.g., a particular or predetermined module). Further, the processor may generate a hash value of the particular module based on the hash value of each of the plurality of cells. In this case, the processor may generate a single string by concatenating the hash values of each of the plurality of cells, and may generate a hash value of the particular module by applying a hash function to the generated string, but the present disclosure is not limited thereto. For example, a hash value of a first module 520_1 may be generated from the hash values of each of the plurality of cells of a first cell group 510_1 included in the first module 520_1.

In an embodiment, the processor may generate a unique hash value of the battery. In more detail, as described above, the processor may generate a hash value of each of the plurality of modules based on the hash values of each of the plurality of cells. Further, the processor may generate a hash value of the battery based on the hash values of each of the plurality of modules. In this case, the processor may generate a single string by concatenating the hash values of each of the plurality of modules, and may generate a hash value of the battery by applying a hash function to the generated string, but the present disclosure is not limited thereto. For example, the processor may generate a hash value of each of the plurality of modules 520_1 to 520_n based on each of a plurality of cell groups 510_1 to 510_n. The processor may generate a hash value of the battery 530 based on the hash values of each of the plurality of modules 520_1 to 520_n.

As such, hash values of not only battery cells, but also modules and battery units, may be generated. Accordingly, the integrity of each of the battery cell, the module, and the battery may be verified. Further, by having the hash values generated according to the methods described above, and stored in the internal memory of the battery management system, it may be possible to preclude security issues and connectivity issues that may arise from using data from an external database or a blockchain network in order to verify the battery integrity.

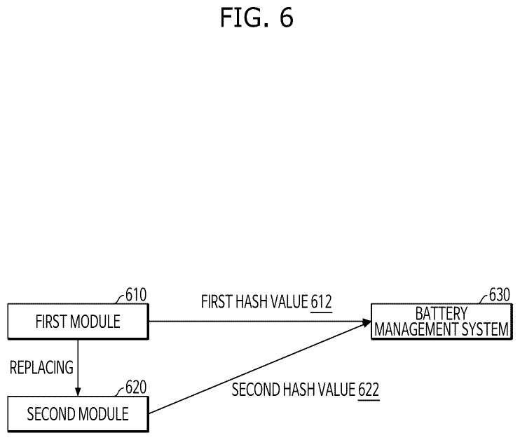

FIG. 6 shows an example of updating a hash value of a module that is a replacement according to an embodiment of the present disclosure. For example, the replacement may be for when the module included in a battery is replaced.

In an embodiment, when a module (e.g., a particular or predetermined module) of the battery is replaced, a processor (e.g., the processor of the integrity verification system) may generate a hash value associated with the replaced module. For example, as described above with reference to FIG. 5, the processor may generate a first hash value 612 of a first module 610, and may store it in a battery management system 630. If (e.g., when) the first module 610 has been replaced with a second module 620, the processor may generate a second hash value 622 associated with the second module 620 based on the hash values of each of a plurality of cells included in the second module 620. Further, the processor may update the first hash value 612 stored in the battery management system 630 to the second hash value 622.

In an embodiment, the processor may generate a hash value of the battery based on the second hash value 622 and the hash values of the existing modules included in the battery. Further, the processor may update the battery management system with the generated hash value of the battery.

In an embodiment, when a cell (e.g., a particular or predetermined cell) included in the module is replaced, the processor may generate a hash value associated with the replaced cell. Further, based on the hash value of each of the replaced cell and the existing cells in the module including the replaced cell, the processor may update the hash value of the corresponding module. Moreover, based on the updated hash value of the corresponding module and the hash values of the existing modules included in the battery, the processor may update the hash value of the battery. As such, the battery integrity may be maintained even if the battery cells and/or the modules are replaced.

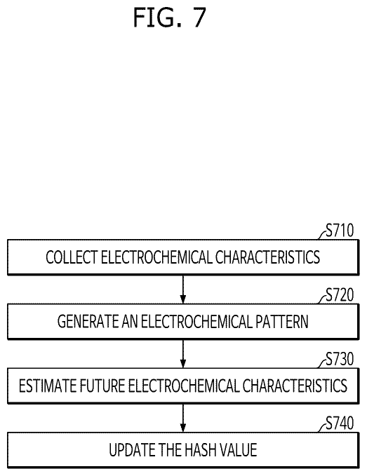

FIG. 7 shows an example of a method of continuously updating hash values according to an embodiment of the present disclosure.

In an embodiment, the hash value updating method may start, and a processor (e.g., at least one processor of a battery management system) may measure and collect electrochemical characteristics of a cell (e.g., a particular or predetermined cell) (S710). In this case, the battery management system may include a circuit for measuring the electrochemical characteristics. Accordingly, data associated with the electrochemical characteristics of the particular cell may be generated. In some embodiments, the electrochemical characteristics of the particular cell may be measured and collected periodically.

The processor may generate an electrochemical pattern of the corresponding cell based on the periodically measured data (S720). The electrochemical pattern may be determined according to changes in the electrochemical characteristics that may occur as the corresponding cell ages. Further, the electrochemical pattern may be a pattern associated with a time domain and a frequency domain of the electrochemical characteristics, but the present disclosure is not limited thereto.

The processor may estimate future electrochemical characteristics of the corresponding cell based on the electrochemical pattern (S730). To estimate the future electrochemical characteristics based on the electrochemical pattern of the particular cell, any of a variety of suitable time series data prediction methods, such as linear regression algorithms, machine learning-based algorithms, and/or the like, may be used. Further, the processor may generate a hash value of the corresponding cell, and may update the existing hash value based on the estimated future electrochemical characteristics (S740). In another example, the processor may generate a hash value of the corresponding cell, and may update the existing hash value based on the measured and collected electrochemical characteristics. Accordingly, the processor may continuously update the hash value associated with the electrochemical characteristics that may change as the battery ages.

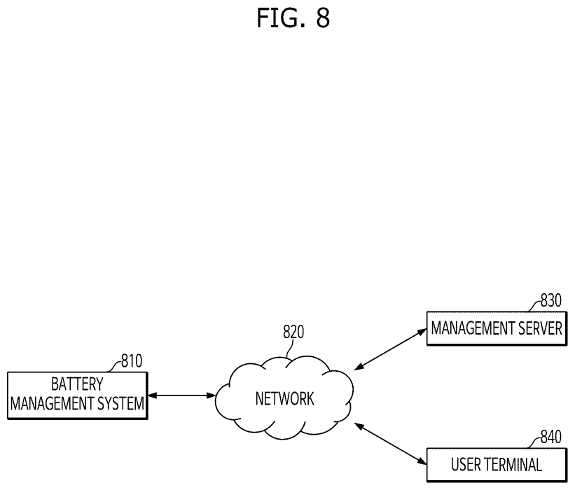

FIG. 8 is a schematic diagram showing a configuration in which a battery management system 810 is communicably connected to a management server 830 and a user terminal 840 in order to provide a notification associated with battery integrity according to an embodiment of the present disclosure.

Referring to FIG. 8, the user terminal 840 may be connected to the battery management system 810 and the management server 830 that may provide the battery integrity notification service via a network 820. The user terminal 840 may include a terminal of a user for receiving the battery integrity notification service, or a terminal associated with a battery manager (e.g., a battery manufacturer).

In an embodiment, the battery management system 810 may include one or more memories, processors, and the like that may store, provide, and execute computer-executable programs (e.g., downloadable applications) and data associated with providing the battery integrity notification service.

The battery integrity notification service provided by the battery management system 810 may be provided to a user via a battery integrity notification service application, web browser, web browser extension program, and/or the like installed on each of the user terminals 840. For example, the battery management system 810 may provide information corresponding to or perform processing corresponding to a battery integrity verification request received from the user terminal 840 via a battery integrity notification service application and/or the like.

In an embodiment, the battery management system 810 may transmit the hash values of the battery cells, the modules, and the batteries to the management server 830 via the network 820. Accordingly, the battery management system 810 and the management server 830 may be synchronized with each other, and may provide information corresponding to or perform processing corresponding to a battery integrity verification request received from the user terminal 840

The user terminal 840 may communicate with the battery management system 810 and/or the management server 830 via the network 820. The network 820 may enable communication between the plurality of user terminals 840, the battery management system 810, and the management server 830. The network 820 may be formed of, for example, a wired network, such as Ethernet, a power line communication, a telephone line communication device, and RS-serial communication, a wireless network, such as a mobile communication network, WLAN (wireless LAN), Wi-Fi, Bluetooth, and ZigBee, or a suitable combination thereof, depending on the installation environment. The communication method is not limited, and not only a communication method utilizing a communication network that the network 820 may include (e.g., a mobile communication network, wired Internet, wireless Internet, a broadcasting network, a satellite network, etc.), but also short-range wireless communication between the user terminals 840 may be included.

In an embodiment, the user terminals 840 may be any computing devices capable of wired and/or wireless communication and capable of having a battery integrity notification service application, web browser, or the like installed and executed thereon. For example, the user terminals may include AI speakers, smartphones, mobile phones, navigation systems, computers, laptops, digital broadcasting terminals, PDAs (personal digital assistants), PMPs (portable multimedia players), tablet PCs, game consoles, wearable devices, IoT (Internet of Things) devices, VR (virtual reality) devices, AR (augmented reality) devices, set-top boxes, etc. Further, a different number of user terminals may be configured to communicate with the battery management system 810 via the network 820.

FIG. 8 shows a configuration by way of example in which a user's request (e.g., a battery integrity verification request) is transferred to the battery management system 810 and/or the management server 830 via the user terminal 840, but the present disclosure is not limited thereto, and the user's request may be provided to the battery management system 810 and/or the management server 830 via an input device associated with the battery management system 810 and/or the management server 830 without going through the user terminal 840. The result of processing the user's request (e.g., a battery integrity verification result) may be provided to the user via an output device (e.g., a display or the like) associated with the battery management system 810 and/or the management server 830.

In an embodiment, the battery management system 810 and/or the management server 830 may transmit a notification associated with the monitoring results of a battery (e.g., a particular or predetermined battery) to the user terminal 840. For example, if (e.g., when) the hash value associated with a cell (e.g., a particular or predetermined cell), a module, or a battery received by the battery management system 810 and/or the management server 830 is different from the hash value that is already stored, a notification indicating that the battery integrity has been negated may be transmitted to a user terminal 840 associated with the corresponding battery.

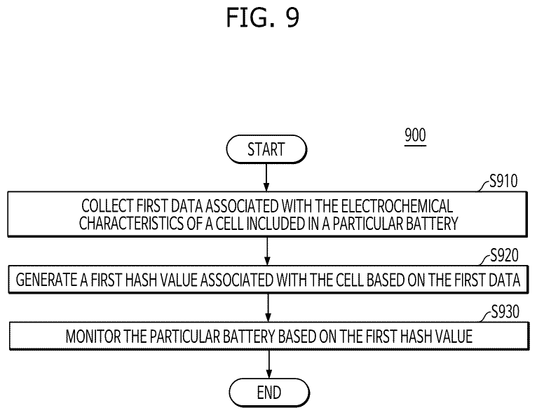

FIG. 9 is a flowchart showing an example of a method 900 of verifying battery integrity according to an embodiment of the present disclosure.

In an embodiment, the method 900 of verifying battery integrity may be performed by at least one processor. The method 900 may start, and the processor may collect first data associated with the electrochemical characteristics of a cell included in a battery (e.g., a particular or predetermined battery) (S910). The first data may include an impedance and a phase angle generated in response to applying a frequency (e.g., a particular or predetermined frequency) and a voltage (e.g., a particular or predetermined voltage) to the cell.

The processor may generate a first hash value associated with the cell based on the first data (S920). In more detail, the processor may preprocess the first data, and may extract features from the preprocessed first data. Further, the processor may generate the first hash value based on the extracted features.

The processor may monitor the particular battery based on the first hash value (S930), and the method 900 may end. In more detail, the processor may collect second data associated with the electrochemical characteristics of the cell. Further, the processor may generate a second hash value associated with the cell based on the second data. The processor may compare the first hash value and the second hash value with each other.

In an embodiment, the processor may perform a noise filtering on the first data. Further, the processor may normalize the noise-filtered first data.

In an embodiment, the processor may generate frequency domain data based on the preprocessed first data. Further, the processor may calculate statistical measurement values from the frequency domain data. The processor may extract features from the statistical measurement values.

In an embodiment, the processor may generate a feature vector based on the features by using a machine learning model. The machine learning model may be trained/pre-trained to cluster input data based on unsupervised learning, and may generate and output unique vectors based on principal component analysis. Further, the processor may generate the first hash value based on the feature vector.

In an embodiment, the processor may generate a hash value of each of a plurality of cells included in a module (e.g., a particular or predetermined module) of the particular battery. Further, the processor may generate a hash value of the particular module based on the hash value of each of the plurality of cells.

In an embodiment, the processor may generate a hash value of each of a plurality of modules included in the particular battery. Further, the processor may generate a hash value of the particular battery based on the hash value of each of the plurality of modules. In this case, the processor may generate hash values associated with the replaced modules in response to replacing at least some of the plurality of modules. Moreover, the processor may update the hash value of the particular battery based on the hash value of each of the rest of the plurality of modules and the replaced modules.

In an embodiment, the processor may determine an integrity status of the particular battery based on the monitoring results of the particular battery. Further, the processor may provide a notification associated with the integrity status based on the integrity status.

In an embodiment, the processor may periodically measure data associated with the electrochemical characteristics of the cell. In this case, a battery management system of the particular battery may include a circuit for measuring the electrochemical characteristics of the cell. Further, the processor may update the first hash value associated with the cell based on the periodically measured data. In more detail, the processor may generate an electrochemical pattern of the cell based on the periodically collected data. The processor may estimate the future electrochemical characteristics of the cell based on the electrochemical pattern of the cell. Furthermore, the processor may update the first hash value based on the estimated future electrochemical characteristics.

In an embodiment, the first hash value and an identifier of the cell may be stored in the battery management system of the particular battery. In another example, the first hash value and the identifier of the cell may be stored in a management server associated with the particular battery. In this case, the management server may transmit a notification associated with the monitoring results of the particular battery to a terminal of a user of the particular battery.

The methods described above may be provided as computer programs stored on a computer-readable recording medium for execution on a computer. The medium may keep the storage of computer-executable programs or temporarily store them for execution or download. Moreover, the medium may be a variety of recording or storage means in the form of a single piece of hardware or a combination of several pieces of hardware, and is not limited to media directly connected to a computer system but may be those distributed over a network. Examples of media may be those configured to store program instructions, including magnetic media such as hard disks, floppy disks, and magnetic tapes, optical recording media such as CD-ROMs and DVDs, magneto-optical media such as floptical disks, ROM, RAM, flash memory, etc. Furthermore, examples of other media may include recording or storage media managed by app stores that distribute applications, sites that supply or distribute various other software, servers, etc.

The methods, operations, or techniques of the present disclosure may be implemented by various means. For example, these techniques may be implemented in hardware, firmware, software, or combinations thereof. Those having ordinary skill in the art will understand that the various example logic blocks, modules, circuits, and algorithm steps described in connection with the disclosure herein may be implemented in electronic hardware, computer software, or a combination of both. To clearly describe this interchangeability of hardware and software, the various example components, blocks, modules, circuits, and steps have been described above generally in terms of their functionality. Whether such functionality is implemented in hardware or software depends on the particular application and design requirements imposed on the overall system. Those having ordinary skill in the art may implement the described functionality in a variety of ways for each particular application, but such implementation should not be construed as departing from the scope of the present disclosure.

In hardware implementation, the processing units used to perform the techniques may be implemented within one or more ASICs, DSPs, GPUs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computers, or combinations thereof.

Therefore, the various example logic blocks, modules, and circuits described in connection with some embodiments of the present disclosure may be implemented or performed in any suitable combination of general-purpose processors, DSPs, ASICs, FPGAs or other programmable logic devices, discrete gate or transistor logic, discrete hardware components, or those designed to perform the functions described herein. The general-purpose processor may be a microprocessor, but in another example, the processor may be any conventional processor, controller, microcontroller, or state machine. The processor may also be implemented as a combination of computing devices, for example, a combination of a DSP and a microprocessor, a plurality of microprocessors, one or more microprocessors in conjunction with a DSP core, or any other configurations.

In firmware and/or software implementation, the techniques may be implemented as commands stored on a computer-readable medium such as random-access memory (RAM), read-only memory (ROM), non-volatile random-access memory (NVRAM), PROM (programmable read-only memory), EPROM (erasable programmable read-only memory), EEPROM (electrically erasable PROM), flash memory, compact discs (CDs), magnetic or optical data storage devices, etc. The commands may be executable by one or more processors, and may cause the processor(s) to perform certain aspects of the functionality described in the present disclosure.

If (e.g., when) implemented in software, the techniques described above may be stored on or transmitted via a computer-readable medium as one or more commands or codes. The computer-readable media include both computer storage media and communication media, including any media that facilitate the transmission of a computer program from one place to another. The storage media may be any available media that can be accessed by a computer. By way of a non-limiting example, the computer-readable media may include RAM, ROM, EEPROM, CD-ROM or other optical disc storages, magnetic disk storage or other magnetic storage devices, or any other media that can be used to transport or store the desired program code in the form of commands or data structures and that can be accessed by a computer. Moreover, any access is appropriately made to a computer-readable medium.

For example, if (e.g., when) software is transmitted from websites, servers, or other remote sources using coaxial cables, fiber optic cables, twisted pair cables, digital subscriber lines (DSLs), or wireless technologies such as infrared, radio, and microwave, then the coaxial cables, fiber optic cables, twisted pair cables, digital subscriber lines, or wireless technologies such as infrared, radio, and microwave fall within the definition of media. The disks and discs used herein include CDs, laser discs, optical discs, digital versatile discs (DVDs), floppy disks, and Blu-ray discs, wherein the disks typically reproduce data magnetically, whereas the discs reproduce data optically using lasers. Combinations of the above should also fall within the scope of computer-readable media.

The software modules may reside in RAM memory, flash memory, ROM memory, EPROM memory, EEPROM memory, registers, a hard disk, a removable disk, a CD-ROM, or any other forms of storage media known. An example storage medium may be connected to the processor such that the processor can read information from or write information to the storage medium. In another example, the storage medium may be integrated into the processor. The processor and storage medium may be present within an ASIC. The ASIC may be present within a user terminal. In yet another example, the processor and storage medium may be present as separate components in a user terminal.

Although the embodiments have been described above as utilizing aspects of the presently disclosed subject matter in one or more standalone computer systems, the present disclosure is not limited thereto but may be implemented in connection with any computing environment, such as a network or distributed computing environment. Furthermore, aspects of the subject matter in the present disclosure may be implemented in a plurality of processing chips or devices, and storage may be affected similarly across a plurality of devices. These devices may include PCs, network servers, and portable devices.

Similarly, the electronic or electric devices and/or any other relevant devices or components according to embodiments of the present disclosure described herein (e.g., the data collection part, the hash generation part, the monitoring part, and/or the like) may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF SOME REFERENCE SYMBOLS

100: Battery integrity verification system
110: Data collection part
120: Hash generation part
130: Monitoring part
140: Battery management system

What is claimed is:

1. A method of verifying battery integrity, comprising:
collecting first data associated with electrochemical characteristics of a cell included in a battery;
generating a first hash value associated with the cell based on the first data; and
monitoring the battery based on the first hash value.

2. The method as claimed in claim 1, wherein the first data comprises an impedance and a phase angle generated in response to applying a frequency and a voltage to the cell.

3. The method as claimed in claim 1, wherein the generating of the first hash value comprises:
preprocessing the first data;
extracting features from the preprocessed first data; and
generating the first hash value based on the extracted features.

4. The method as claimed in claim 3, wherein the preprocessing comprises:
performing a noise filtering on the first data; and
normalizing the noise-filtered first data.

5. The method as claimed in claim 3, wherein the extracting of the features comprises:
generating frequency domain data based on the preprocessed first data;
calculating statistical measurement values from the frequency domain data; and
extracting the features from the statistical measurement values.

6. The method as claimed in claim 3, wherein the generating of the first hash value comprises:
generating, by a machine learning model, a feature vector based on the features; and
generating the first hash value based on the feature vector.

7. The method as claimed in claim 6, wherein the machine learning model is trained to cluster input data based on unsupervised learning, and generate and output unique vectors based on principal component analysis.

8. The method as claimed in claim 1, wherein the first hash value and an identifier of the cell are stored in a battery management system (BMS) of the battery.

9. The method as claimed in claim 1, wherein the monitoring of the battery comprises:
collecting second data associated with the electrochemical characteristics of the cell;
generating a second hash value associated with the cell based on the second data; and
comparing the first hash value and the second hash value with each other.

10. The method as claimed in claim 1, further comprising:
generating a hash value of each of a plurality of cells included in a module of the battery; and
generating a hash value of the module based on the hash value of each of the plurality of cells.

11. The method as claimed in claim 1, further comprising:
generating a hash value of each of a plurality of modules included in the battery; and
generating a hash value of the battery based on the hash value of each of the plurality of modules.

12. The method as claimed in claim 11, further comprising:
generating hash values associated with replaced modules in response to replacing at least some of the plurality of modules; and
updating the hash value of the battery based on the hash value of each of rest of the plurality of modules and the replaced modules.

13. The method as claimed in claim 1, further comprising determining an integrity status of the battery based on monitoring results of the battery.

14. The method as claimed in claim 13, further comprising providing a notification associated with the integrity status based on the integrity status.

15. The method as claimed in claim 1, wherein the monitoring comprises:
periodically measuring data associated with the electrochemical characteristics of the cell; and
updating the first hash value associated with the cell based on the periodically measured data.

16. The method as claimed in claim 15, wherein the updating of the first hash value comprises:
generating an electrochemical pattern of the cell based on the periodically measured data;
estimating future electrochemical characteristics of the cell based on the electrochemical pattern of the cell; and
updating the first hash value based on the estimated future electrochemical characteristics.

17. The method as claimed in claim 15, wherein a battery management system of the battery comprises a circuit for measuring the electrochemical characteristics of the cell.

18. The method as claimed in claim 1, wherein the first hash value and an identifier of the cell are stored in a management server associated with the battery, and
wherein the management server transmits a notification associated with monitoring results of the battery to a terminal of a user of the battery.

19. A computer-readable non-transitory recording medium having recorded thereon instructions for executing, on a computer, the method according to claim 1.

20. A system for verifying battery integrity, comprising:
a data collection part configured to collect data associated with electrochemical characteristics of a cell included in a battery;
a hash generation part configured to generate a hash value associated with the cell based on the data; and
a monitoring part configured to monitor the battery based on the hash value.
